(19) United States
(12) Patent Application Publication
(10) Pub. No.: US 2023/0344361 A1
(43) Pub. Date: Oct. 26, 2023

(54) SEMICONDUCTOR DEVICE AND SEMICONDUCTOR MODULE

(71) Applicant: FUJI ELECTRIC CO., LTD., Kawasaki-shi (JP)

(72) Inventor: Seiki IGARASHI, Saitama-city (JP)

(73) Assignee: FUJI ELECTRIC CO., LTD., Kawasaki-shi (JP)

(21) Appl. No.: 18/172,698

(22) Filed: Feb. 22, 2023

(30) Foreign Application Priority Data
Apr. 22, 2022 (JP) 2022-070784

(51) Int. Cl. H02M 7/00; H02M 1/00

(52) U.S. Cl. CPC H02M 7/003; H02M 1/0038

(57) ABSTRACT

A semiconductor device includes a first semiconductor module and a second semiconductor module that are connected in parallel between the positive terminal and the negative terminal of a direct-current power source. The first semiconductor module includes a first input terminal electrically connected to the positive terminal, a second input terminal electrically connected to the negative terminal, a first housing, and a first wiring bar that is provided in the first housing and is electrically connected to the first input terminal. The second semiconductor module includes a third input terminal electrically connected to the positive terminal, a fourth input terminal electrically connected to the negative terminal, a second housing, and a second wiring bar that is provided in the second housing, is electrically connected to the fourth input terminal, and is magnetically coupled to the first wiring bar.

### CROSS-REFERENCE TO RELATED APPLICATION

This application is based upon and claims the benefit of priority of the prior Japanese Patent Application No. 2022-070784, filed on Apr. 22, 2022, the entire contents of which are incorporated herein by reference.

### BACKGROUND OF THE INVENTION

### 1. Field of the Invention

The embodiments discussed herein relate to a semiconductor device having a plurality of semiconductor modules connected in parallel, and a semiconductor module.

### 2. Background of the Related Art

Conventionally, in order to improve the current carrying capability, a plurality of semiconductor modules including switching elements such as insulated gate bipolar transistors (IGBTs) and power metal oxide semiconductor field effect transistors (MOSFETs) may be connected in parallel.

There may occur an imbalance in current at the time of switching between the plurality of semiconductor modules connected in parallel. To reduce the current imbalance, a technique of equalizing, as much as possible, the inductances of wires from a direct-current power source to the respective semiconductor modules, and other techniques are used.

In this connection, there is a technique of detecting circulating currents flowing through wires connecting to the emitters of switching elements connected in parallel and controlling the on and off of each switching element using a gate drive circuit on the basis of the detection results (see, for example, Japanese Laid-open Patent Publication No. 2015-149828).

Further, there is a technique of magnetically coupling reactors connected to a positive-side or negative-side input terminal in adjacent ones of a plurality of chopper circuits connected in parallel (see, for example, Japanese Laid-open Patent Publication No. 2017-085787). Still further, there is a technique of magnetically coupling conductive paths connected to the gates of a plurality of semiconductor switching elements connected in parallel (see, for example, Japanese Laid-open Patent Publication No. 2016-046842). Yet still further, there is a technique of magnetically coupling drive paths and main current paths provided for a pair of switching elements connected in parallel (see, for example, Japanese Laid-open Patent Publication No. 2020-005436). Yet still further, in a configuration where a plurality of series circuits each formed of a plurality of IGBTs connected in series are connected in parallel, there is a technique of magnetically coupling the emitter lines of the plurality of IGBTs connected in series with magnetic circuits formed of a magnetic body (see, for example, Japanese Laid-open Patent Publication No. 2006-149169).

Yet still further, there is a technique of arranging an annular magnetic member so as to surround the positive-side and negative-side direct-current input terminals of the same semiconductor module and causing the annular magnetic member to operate as an inductor for removing common mode noise (see, for example, Japanese Laid-open Patent Publication No. 2005-183776). Yet still further, there is a technique of setting a ring-shaped magnetic member around a semiconductor module package so as to surround power semiconductor element chips such as IGBTs, in order to suppress noise current (see, for example, Japanese Laid-open Patent Publication No. 2006-351986).

Yet still further, there is known a technique of connecting a plurality of half-bridge circuits in parallel in one semiconductor module (see, for example, International Publication Pamphlet No. WO 2013/128787).

Even if the inductances of wires from a direct-current power source to each of a plurality of semiconductor modules connected in parallel are equalized as much as possible in order to reduce the current imbalance, a difference in switching speed between the semiconductor modules leads to an imbalance in the current sharing and thus to more current imbalance.

In this connection, for example, in the case of using a gate drive circuit as described in Japanese Laid-open Patent Publication No. 2015-149828 to control switching speeds, it would be difficult to equalize the switching speeds of the semiconductor modules due to operational delays of a current detection circuit and gate drive circuit. It would also be difficult to apply to recently developed switching elements that perform high-speed switching operations, especially to high-speed semiconductor switching elements that operate at several nanoseconds, such as SiC-MOSFETs.

### SUMMARY OF THE INVENTION

According to one aspect, there is provided a semiconductor device for connection to a positive terminal and a negative terminal of a direct-current power source, the semiconductor device including: a plurality of semiconductor modules connected in parallel between the positive terminal and the negative terminal of the direct-current power source, the plurality of semiconductor modules including: a first semiconductor module, including: a first input terminal electrically connected to the positive terminal, a second input terminal electrically connected to the negative terminal, a first housing, and a first wiring bar that is provided in the first housing and is electrically connected to the first input terminal; and a second semiconductor module, including: a third input terminal electrically connected to the positive terminal, a fourth input terminal electrically connected to the negative terminal, a second housing, and a second wiring bar that is provided in the second housing, is electrically connected to the fourth input terminal, and is magnetically coupled to the first wiring bar.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a top view schematically illustrating a part of a semiconductor device according to a first embodiment;

FIG. 2 illustrates an example of an equivalent circuit of the semiconductor device according to the first embodiment;

FIG. 3 illustrates an example of the operation of the semiconductor device according to the first embodiment;

FIG. 4 illustrates a semiconductor device of a comparative example;

FIG. 5 is a perspective view of a semiconductor module in the semiconductor device of the comparative example;

FIG. 6 is a top view illustrating an example of the configuration of the semiconductor module inside its housing in the semiconductor device of the comparative example;

FIG. 7 is a view of the inside of the housing seen from the arrow A of FIG. 6;

FIG. 8 illustrates an equivalent circuit of the semiconductor module in the semiconductor device of the comparative example;

FIG. 9 is a top view illustrating an example of the configuration of a semiconductor module inside its housing in the semiconductor device according to the first embodiment;

FIG. 10 is a view of the inside of the housing seen from the arrow A of FIG. 9;

FIG. 11 is a top view schematically illustrating a part of a semiconductor device according to a second embodiment;

FIG. 12 illustrates an example of a magnetic core;

FIG. 13 illustrates an example of hollows formed in housings (part 1);

FIG. 14 illustrates the example of a hollow formed in a housing (part 2); and

FIG. 15 is a top view of a semiconductor module, illustrating an example in which wiring bars are formed inside the resin of sidewalls.

### DETAILED DESCRIPTION OF THE INVENTION

Hereinafter, embodiments will be described with reference to the accompanying drawings. In the following description, the terms “up” and “down” are used for convenience to describe relative positional relationships, and do not limit the technical ideas of the embodiments. For example, the terms “up” and “down” do not always mean vertical directions with respect to the ground. That is, the “upward” and “downward” directions are not limited to the gravity direction.

### First Embodiment

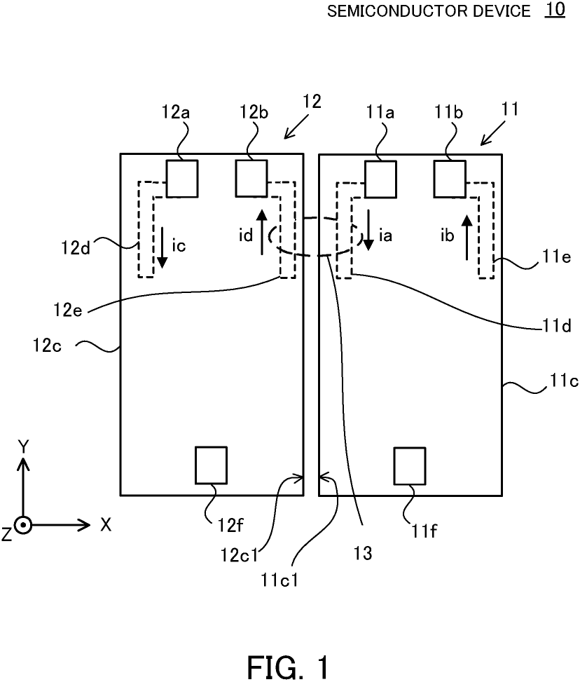

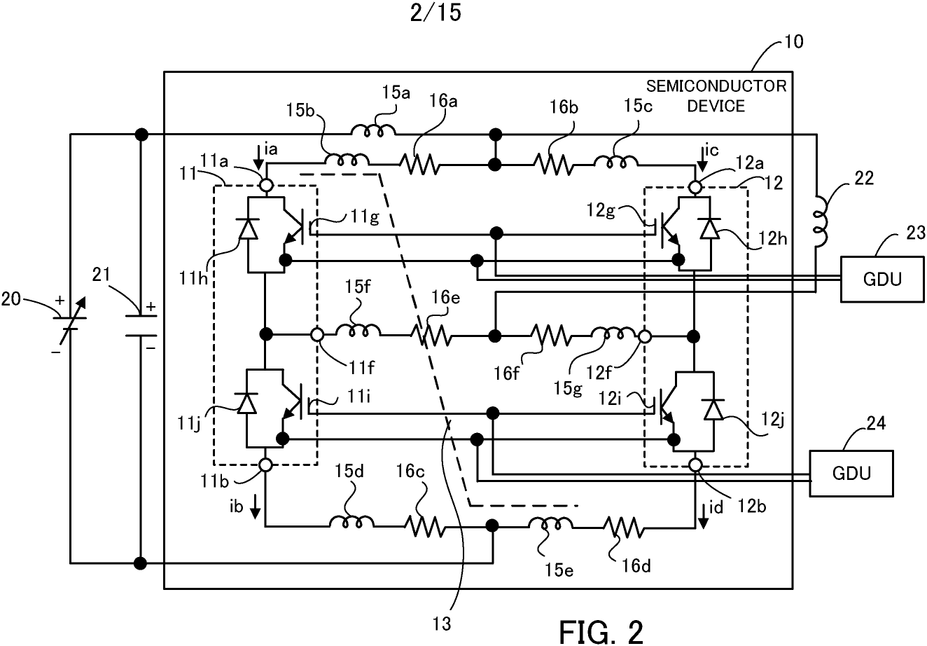

FIG. 1 is a top view schematically illustrating a part of a semiconductor device according to a first embodiment. FIG. 2 illustrates an example of an equivalent circuit of the semiconductor device according to the first embodiment.

The semiconductor device 10 includes a first semiconductor module (hereinafter, referred to as a semiconductor module 11) and a second semiconductor module (hereinafter, referred to as a semiconductor module 12) that are connected in parallel between the positive terminal and the negative terminal of a direct-current power source 20 as illustrated in FIG. 2. In FIG. 2, the positive terminal and negative terminal of the direct-current power source 20 are represented by signs “+” and “-,” respectively. In this connection, a capacitor 21 that is connected in parallel to the direct-current power source 20 of FIG. 2 may be called a direct-current power source.

Although FIGS. 1 and 2 illustrate an example in which the two semiconductor modules 11 and 12 are connected in parallel, three or more semiconductor modules may be connected in parallel.

The semiconductor module 11 includes a first input terminal (hereinafter, referred to as a P terminal 11a) electrically connected to the positive terminal of the direct-current power source 20 and a second input terminal (hereinafter, referred to as an N terminal 11b) electrically connected to the negative terminal of the direct-current power source 20. In addition, the semiconductor module 11 includes a first housing (hereinafter, referred to as a housing 11c) and a first wiring bar (hereinafter, referred to as a wiring bar 11d) that is provided in the housing 11c and is electrically connected to the P terminal 11a as illustrated in FIG. 1. The semiconductor module 11 may also include a wiring bar 11e that is electrically connected to the N terminal 11b as illustrated in FIG. 1. In addition, the semiconductor module 11 includes an output terminal (hereinafter, referred to as a U terminal 11f).

The semiconductor module 12 has the same components as the semiconductor module 11. More specifically, the semiconductor module 12 includes a third input terminal (hereinafter, referred to as a P terminal 12a) electrically connected to the positive terminal of the direct-current power source 20 and a fourth input terminal (hereinafter, referred to as an N terminal 12b) electrically connected to the negative terminal of the direct-current power source 20. In addition, the semiconductor module 12 includes a second housing (hereinafter, referred to as a housing 12c) and a second wiring bar (hereinafter, referred to as a wiring bar 12e) that is provided in the housing 12c and is electrically connected to the N terminal 12b as illustrated in FIG. 1. The wiring bar 12e is magnetically coupled to the wiring bar 11d of the semiconductor module 11. That is, magnetic coupling 13 is generated as illustrated in FIG. 1.

In the example of FIG. 1, the wiring bars 11d and 12e are disposed close to each other in a first direction (the X direction in the example of FIG. 1) with a first sidewall (a sidewall 11c1 in the example of FIG. 1) of the housing 11c and a second sidewall (a sidewall 12c1 in the example of FIG. 1) of the housing 12c therebetween. Thereby, the wiring bars 11d and 12e are magnetically coupled to each other.

As the distance in the X direction between the wiring bars 11d and 12e becomes smaller, the magnetic coupling therebetween increases (the mutual inductance increases). Considering that the influence of thermal interference becomes large if the distance is too small, the distance is set to approximately 2 to 3 cm. The distance is not necessarily limited to this numerical range. A magnetic core may be used to further increase the mutual inductance (refer to a second embodiment to be described later).

The semiconductor module 12 may also include a wiring bar 12d that is electrically connected to the P terminal 12a, as illustrated in FIG. 1. In addition, the semiconductor module 12 includes an output terminal (hereinafter, referred to as a U terminal 12f).

In FIG. 1, the wiring bars 11d, 11e, 12d, and 12e are provided in the housings 11c and 12c, and are therefore indicated by dotted lines. In addition, FIG. 1 illustrates a terminal current ia at the P terminal 11a, a terminal current ib at the N terminal 11b, a terminal current ic at the P terminal 12a, and a terminal current id at the N terminal 12b.

In this connection, components other than the wiring bars 11d, 11e, 12d, and 12e inside the housings 11c and 12c are not illustrated in FIG. 1. The housings 11c and 12c are made of a resin. The configurations inside the housings 11c and 12c will be described later. An equivalent circuit of the semiconductor device 10 will be represented as below.

FIG. 2 illustrates an example of an equivalent circuit of the semiconductor device 10 including the semiconductor modules 11 and 12.

As illustrated in FIG. 2, the semiconductor module 11 includes IGBTs 11g and 11i, which are examples of switching elements, and diodes 11h and 11j. The collector of the IGBT 11g and the cathode of the diode 11h are connected to the P terminal 11a, and the emitter of the IGBT 11g and the anode of the diode 11h are connected to the U terminal 11f, the collector of the IGBT 11i, and the cathode of the diode 11j. The emitter of the IGBT 11i and the anode of the diode 11j are connected to the N terminal 11b.

As with the semiconductor module 11, the semiconductor module 12 includes IGBTs 12g and 12i, which are examples of switching elements, and diodes 12h and 12j. The collector of the IGBT 12g and the cathode of the diode 12h are connected to the P terminal 12a, and the emitter of the IGBT 12g and the anode of the diode 12h are connected to the U terminal 12f, the collector of the IGBT 12i, and the cathode of the diode 12j. The emitter of the IGBT 12i and the anode of the diode 12j are connected to the N terminal 12b.

A gate driver unit (GDU) 23 that drives the IGBTs 11g and 12g is connected between the gates of the IGBTs 11g and 12g and between the emitters thereof. A GDU 24 that drives the IGBTs 11i and 12i is connected between the gates of the IGBTs 11i and 12i and between the emitters thereof.

In addition, FIG. 2 illustrates wiring inductances 15a, 15b, and 15c and wiring resistances 16a and 16b in the wiring (a copper bar or the like) connecting the positive terminal of the direct-current power source 20 and each P terminal 11a and 12a. Further, FIG. 2 illustrates wiring inductances 15d and 15e and wiring resistances 16c and 16d in the wiring (a copper bar or the like) connecting the negative terminal of the direct-current power source 20 and each N terminal 11b and 12b. Still furthermore, FIG. 2 illustrates wiring inductances 15f and 15g and wiring resistances 16e and 16f in the wiring connecting each U terminal 11f and 12f and a load 22.

In this connection, the magnetic coupling 13 illustrated in FIG. 1 is also illustrated in FIG. 2.

The magnetic coupling 13 illustrated in FIGS. 1 and 2 is generated. Therefore, when the terminal current ia at the P terminal 11a and the terminal current id at the N terminal 12b become different, an induced voltage of V = M × d(ia - id)/dt is generated, and the terminal currents ia and id are equalized. Here, M denotes a mutual inductance.

This will be described more concretely.

When the terminal current ia in the semiconductor module 11 is higher than the terminal current id in the semiconductor module 12, a voltage of V = M × d(ia - id)/dt is applied between the P terminal 11a and the N terminal 11b of the semiconductor module 11, which reduces the terminal currents ia and ib.

When the terminal current ia in the semiconductor module 11 is lower than the terminal current id in the semiconductor module 12, a voltage of V = M × d(ia - id)/dt is applied between the P terminal 11a and the N terminal 11b of the semiconductor module 11, which increases the terminal currents ia and ib. As a result, equal current sharing is achieved between the semiconductor modules 11 and 12.

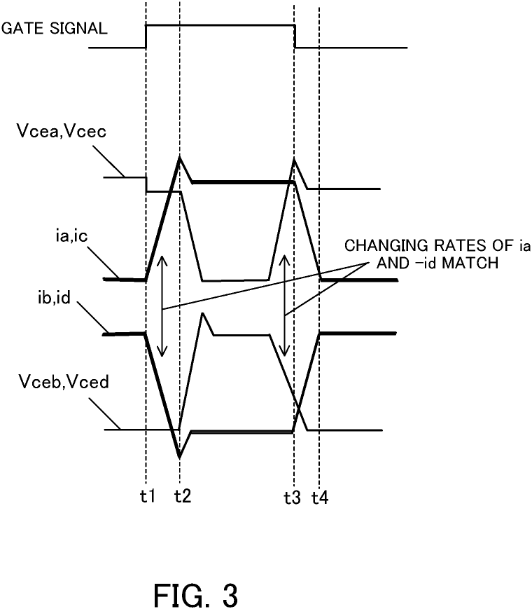

FIG. 3 illustrates an example of the operation of the semiconductor device according to the first embodiment.

FIG. 3 illustrates temporal changes in the gate signal supplied from the GDU 23 to the gates of the IGBTs 11g and 12g, the voltage Vcea between the collector and emitter of the IGBT 11g, and the voltage Vcec between the collector and emitter of the IGBT 12g. Further, FIG. 3 illustrates temporal changes in the voltage Vceb between the collector and emitter of the IGBT 11i and the voltage Vced between the collector and emitter of the IGBT 12i. Still further, FIG. 3 illustrates temporal changes in the terminal current ia at the P terminal 11a, the terminal current ib at the N terminal 11b, the terminal current ic at the P terminal 12a, and the terminal current id at the N terminal 12b.

In this connection, although the gate signal supplied from the GDU 24 to the gates of the IGBTs 11i and 12i is not illustrated in FIG. 3, the gate signal has a phase opposite to that of the gate signal illustrated in FIG. 3.

The period between times t1 to t2 is a turn-on period of the IGBTs 11g and 12g, and the period between times t3 to t4 is a turn-off period of the IGBTs 11g and 12g.

As illustrated in FIG. 3, the magnetic coupling 13 is generated during both the turn-on period and the turn-off period, so that d(ia)/dt = -d(id)/dt is obtained. That is, the changing rates of ia and -id match. As a result, d(ia)/dt = d(ic)/dt and d(ib)/dt = d(id)/dt are obtained.

### Comparative Example

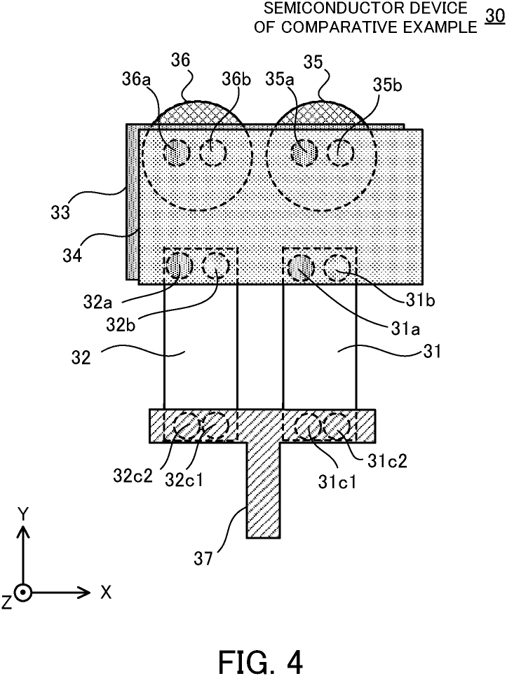

FIG. 4 illustrates a semiconductor device of a comparative example.

The semiconductor device 30 of the comparative example includes semiconductor modules 31 and 32. The semiconductor module 31 includes a P terminal 31a, an N terminal 31b, and U terminals 31c1 and 31c2. The semiconductor module 32 includes a P terminal 32a, an N terminal 32b, and U terminals 32c1 and 32c2.

The P terminals 31a and 32a are electrically connected to the positive terminals 35a and 36a of capacitors 35 and 36 that serve as direct-current power sources, via a laminate bar (a laminate of an insulating film and a metal conductor) 33.

The N terminals 31b and 32b are electrically connected to the negative terminals 35b and 36b of the capacitors 35 and 36 that serve as direct-current power sources, via a laminate bar 34.

The U terminals 31c1, 31c2, 32c1, and 32c2 are connected to an output bar 37.

The following describes an example of the semiconductor module 31. In this connection, the semiconductor module 32 has the same configuration as the semiconductor module 31.

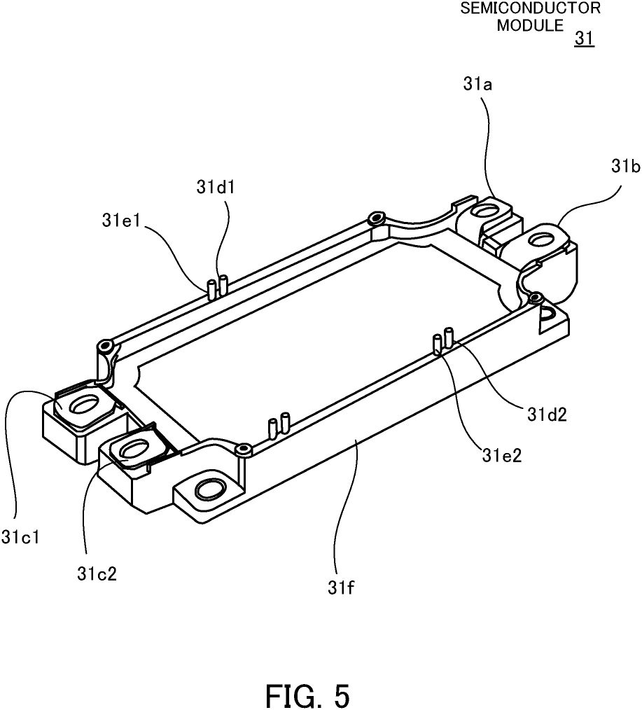

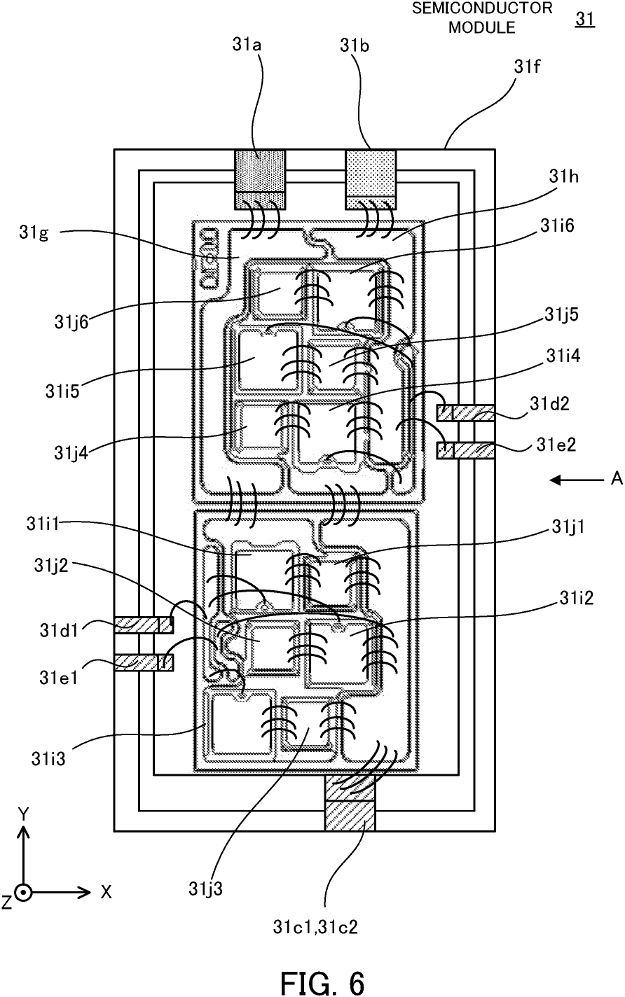

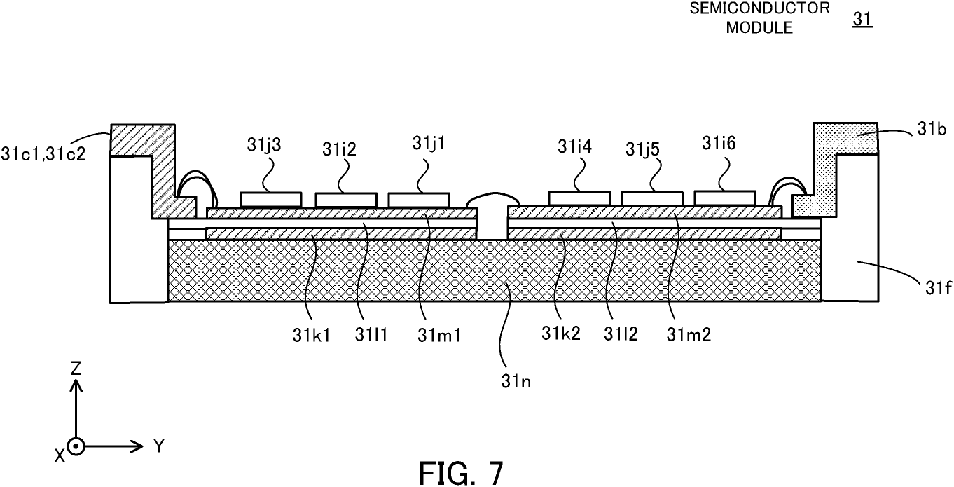

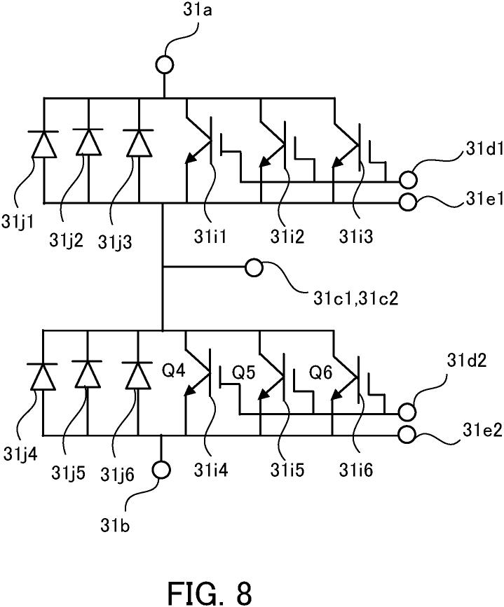

FIG. 5 is a perspective view of a semiconductor module in the semiconductor device of the comparative example. FIG. 6 is a top view illustrating an example of the configuration of the semiconductor module inside its housing in the semiconductor device of the comparative example. FIG. 7 is a view of the inside of the housing seen from the arrow A of FIG. 6. FIG. 8 illustrates an equivalent circuit of the semiconductor module in the semiconductor device of the comparative example.

The semiconductor module 31 in the semiconductor device 30 of the comparative example includes gate terminals 31d1 and 31d2 and emitter terminals 31e1 and 31e2, in addition to the P terminal 31a, N terminal 31b, and U terminals 31c1 and 31c2. In addition, as illustrated in FIG. 6, the semiconductor module 31 includes, inside the housing 31f, IGBTs 31i1, 31i2, and 31i3 and diodes 31j1, 31j2, and 31j3, which are electrically connected to the P terminal 31a via a wiring pattern 31g. The semiconductor module 31 also includes, inside the housing 31f, IGBTs 31i4, 31i5, and 31i6 and diodes 31j4, 31j5, and 31j6, which are electrically connected to the N terminal 31b via a wiring pattern 31h.

In addition, as illustrated in FIG. 7, the semiconductor module 31 includes a laminate body formed by laminating a metal plate 31k1, a ceramic insulating plate 31l1, and a circuit substrate 31m1 in order from the bottom, and a laminate body formed by laminating a metal plate 31k2, an insulating plate 31l2, and a circuit substrate 31m2 in order from the bottom.

The metal plates 31k1 and 31k2 spread in almost the same range as the circuit substrates 31m1 and 31m2, respectively, on the X-Y plane. The metal plates 31k1 and 31k2 are provided so as to prevent warpage of the circuit substrates 31m1 and 31m2 due to differences in thermal expansion coefficient between the circuit substrates 31m1 and 31m2 and the insulating plates 31l1 and 31l2. Note that the metal plates 31k1 and 31k2 are able to cancel the stress caused by the thermal expansion.

The reason why the two separate circuit substrates 31m1 and 31m2 are provided is because, as the area of a substrate becomes larger, the substrate is easier to warp, the manufacturing yield decreases, and the price rises. The circuit substrates 31m1 and 31m2 are conductively connected to each other with a wire.

Each of the IGBTs (IGBTs 31i2, 31i4, and 31i6 in the example of FIG. 7) and diodes (diodes 31j1, 31j3, and 31j5 in the example of FIG. 7) is formed on either the circuit substrate 31m1 or 31m2.

The above-described laminate bodies are disposed on a base plate 31n that is made of a metal (for example, copper). To expand the heat spreading area, the base plate 31n is formed thicker than the metal plates 31k1 and 31k2. The metal plates 31k1 and 31k2 are bonded to the base plate 31n via a solder, for example.

As illustrated in FIG. 8, the P terminal 31a is connected to the collectors of the IGBTs 31i1 to 31i3 and the cathodes of the diodes 31j1 to 31j3. The emitters of the IGBTs 31i1 to 31i3 and the anodes of the diodes 31j1 to 31j3 are connected to the U terminals 31c1 and 31c2, the collectors of the IGBTs 31i4 to 31i6, and the cathodes of the diodes 31j4 to 31j6. The gate terminal 31d1 is connected to the gates of the IGBTs 31i1 to 31i3, and the emitter terminal 31e1 is connected to the emitters of the IGBTs 31i1 to 31i3.

The emitters of the IGBTs 31i4 to 31i6 and the anodes of the diodes 31j4 to 31j6 are connected to the N terminal 31b. The gate terminal 31d2 is connected to the gates of the IGBTs 31i4 to 31i6, and the emitter terminal 31e2 is connected to the emitters of the IGBTs 31i4 to 31i6.

The equivalent circuit of the semiconductor device 30 of the comparative example described above is entirely equal to that of the semiconductor device 10 of the first embodiment illustrated in FIG. 2. In the case of using the semiconductor module 31 having the circuit configuration as illustrated in FIG. 8, the IGBTs 31i1 to 31i3 correspond to the IGBT 11g of FIG. 2, and the diodes 31j1 to 31j3 correspond to the diode 11h of FIG. 2. The IGBTs 31i4 to 31i6 correspond to the IGBT 11i of FIG. 2, and the diodes 31j4 to 31j6 correspond to the diode 11j of FIG. 2.

However, in the semiconductor device 30 of the comparative example, the magnetic coupling 13 as illustrated in FIGS. 1 and 2 is not generated.

To reduce current imbalance between the semiconductor modules 31 and 32 in the semiconductor device 30 of the comparative example, it is conceivable to equalize, as much as possible, the values of the wiring resistances 16a and 16b illustrated in FIG. 2, and likewise to equalize, as much as possible, the values of the wiring inductances 15b and 15c, the values of the wiring resistances 16c and 16d, the values of the wiring inductances 15d and 15e, the values of the wiring resistances 16e and 16f, and the values of the wiring inductances 15f and 15g. However, if there is a difference in switching speed between the semiconductor modules 31 and 32, this leads to an imbalance in the current sharing and thus to more current imbalance. To avoid this, it may be done to select semiconductor modules 31 and 32 having an equal switching speed and connect them in parallel. However, there needs a selection cost and a management cost. In addition, as the number of semiconductor modules connected in parallel increases, the current imbalance may increase. For this reason, it is not reasonable to increase much the number of semiconductor modules connected in parallel.

In this connection, as described earlier, even if the switching speed is controlled using a gate drive circuit as described in Japanese laid-open Patent Publication No. 2015-149828, it is difficult to equalize the switching speeds of the semiconductor modules 31 and 32 due to operational delays of a current detection circuit and gate drive circuit.

In contrast to the above-described semiconductor device 30 of the comparative example, the semiconductor device 10 according to the first embodiment generates the magnetic coupling 13 using the wiring bars 11d and 11e as illustrated in FIG. 1, so as to equalize the terminal currents ia and id. Thereby, even if the semiconductor modules 31 and 32 connected in parallel have different switching speeds, it is possible to achieve equal current sharing between the semiconductor modules 31 and 32.

In addition, a semiconductor module similar to the semiconductor modules 11 and 12 as illustrated in FIG. 1 may additionally be arranged in the X direction, and a pair of wiring bars similar to the wiring bars 11d and 11e may be arranged in adjacent semiconductor modules to generate magnetic coupling. By doing so, the same effect is produced. Therefore, it is possible to further increase the number of semiconductor modules connected in parallel, and it is easy to configure a device with large capacity.

In this connection, three semiconductor devices 10 as described above may be provided so as to configure a three-phase inverter. In order to prevent the magnetic coupling between the semiconductor devices of the respective phases, an iron plate may be inserted between the semiconductor devices of the respective phases. Alternatively, the wiring bar 11e or wiring bar 12d as illustrated in FIG. 1 may be excluded.

(Example of semiconductor module in semiconductor device according to first embodiment)

The following describes an example of the semiconductor module 11 in the semiconductor device 10 according to the first embodiment. In this connection, the semiconductor module 12 may have the same configuration as the semiconductor module 11.

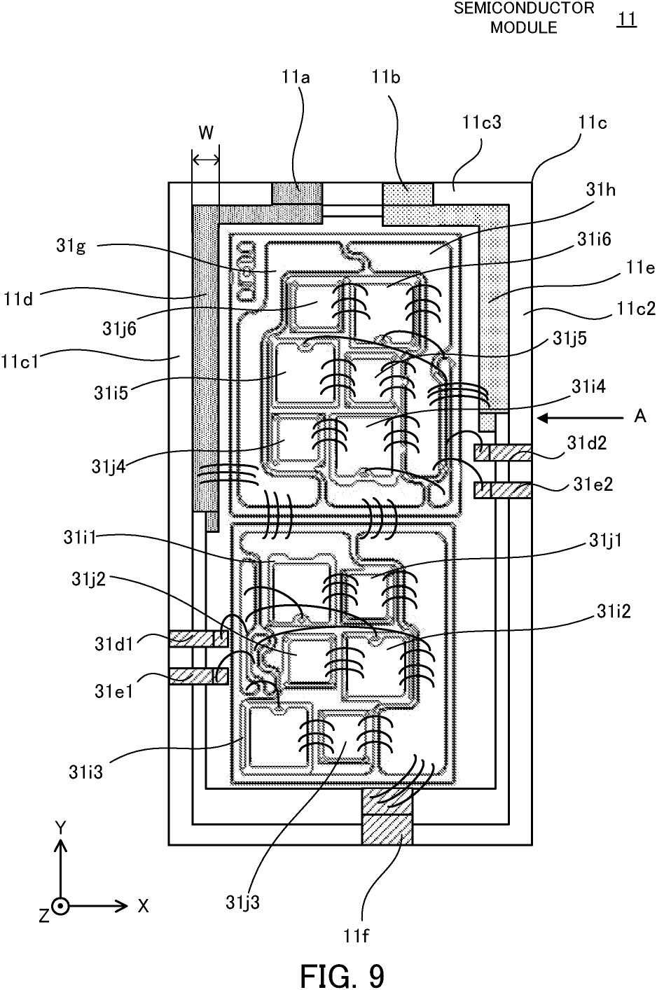

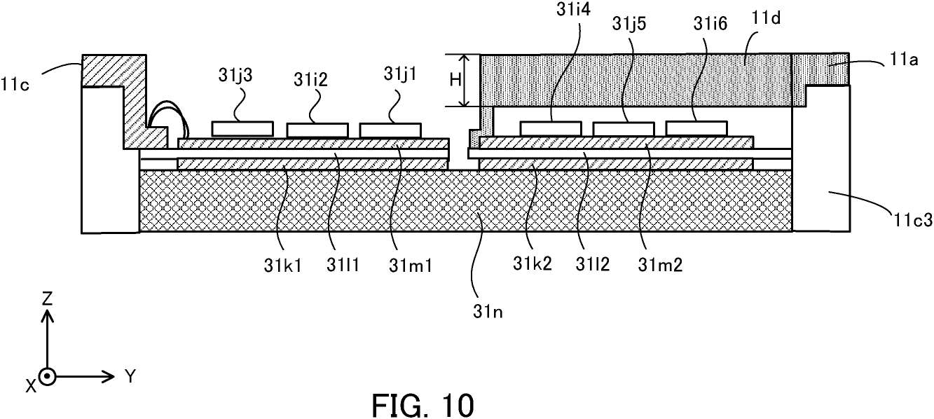

FIG. 9 is a top view illustrating an example of the configuration of a semiconductor module inside its housing in the semiconductor device according to the first embodiment. FIG. 10 is a view of the inside of the housing seen from the arrow A of FIG. 9. In this connection, the same reference numerals as used in FIGS. 6 and 7 are given to the corresponding components in FIGS. 9 and 10.

The wiring bar 11d electrically connected to the P terminal 11a is arranged along the sidewall 11c1 of the housing 11c.

That is, the wiring bar 11d is formed so as to extend in the extending direction (the Y direction in FIG. 9) of the sidewall 11c1.

The wiring bar 11e electrically connected to the N terminal 11b is disposed along the sidewall 11c2 of the housing 11c that faces the sidewall 11c1. That is, the wiring bar 11e is formed so as to extend in the extending direction (the Y direction in FIG. 9) of the sidewall 11c2.

In this connection, the wiring bars 11d and 11e are electrically connected to the outside of the housing 11c from the resin of the sidewall 11c3 that is provided between the sidewall 11c1 and the sidewall 11c2 to connect an end of the sidewall 11c1 and an end of the sidewall 11c2.

In the example of FIG. 9, the wiring bar 11d is inscribed to the resin of the sidewall 11c1, and the wiring bar 11e is inscribed to the resin of the sidewall 11c2. The state of being inscribed means that a wiring bar contacts the resin of the sidewall 11c1 or the resin of the sidewall 11c2 from the inside of the housing 11c.

By inscribing the wiring bar 11d to the resin of the sidewall 11c1 and the wiring bar 11e to the resin of the sidewall 11c2, it is possible to shorten the distance to a wiring bar (the wiring bar 12e in the example of FIG. 1) of a semiconductor module arranged adjacently in the X direction. This further increases the mutual inductance and enhances an effect of equalizing the current sharing.

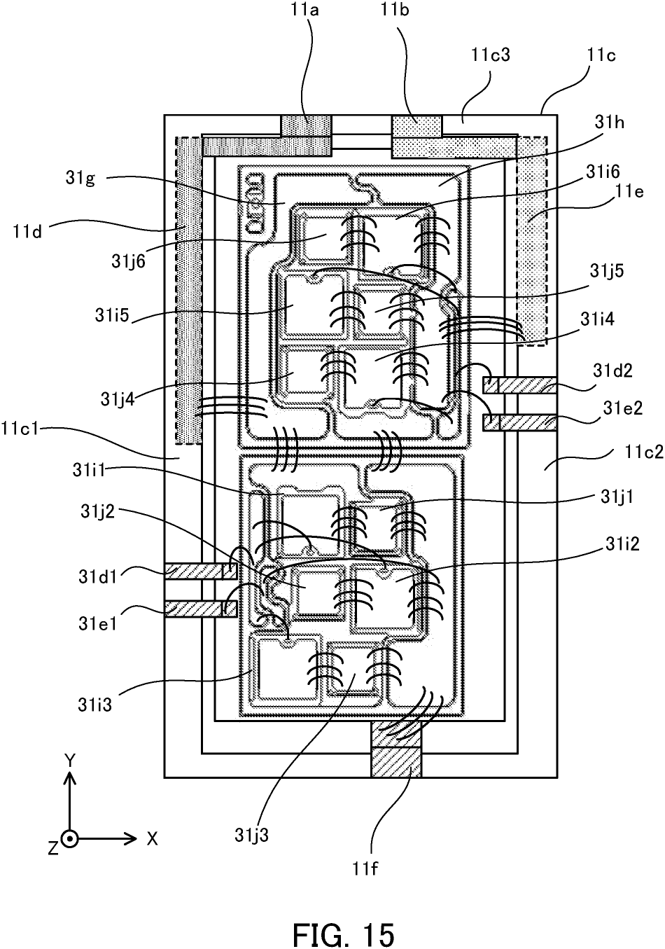

Alternatively, the wiring bar 11d may be formed inside the resin of the sidewall 11c1 and the wiring bar 11e may be formed inside the resin of the sidewall 11c2 (see FIG. 15 illustrating a modification to be described later). This case further increases the mutual inductance and further enhances the effect of equalizing the current sharing.

In addition, the length (H in FIG. 10) of the wiring bar 11d in the height direction (the Z direction in FIGS. 9 and 10) of the sidewalls 11c1 and 11c2 is greater than the length (W in FIG. 9) of the wiring bar 11d in the X direction. The same applies to the wiring bar 11e, although it is not illustrated. This prevents an increase in the length of the semiconductor module 11 in the X direction due to the arrangement of the wiring bars 11d and 11e.

### Second Embodiment

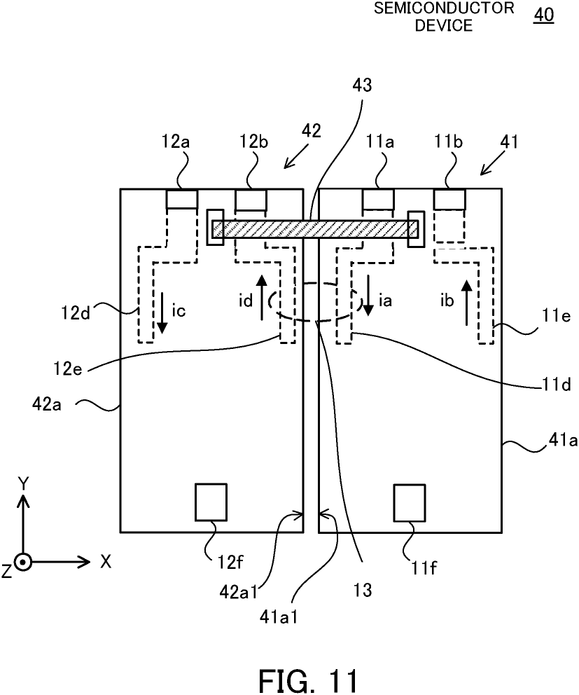

FIG. 11 is a top view schematically illustrating a part of a semiconductor device according to a second embodiment. The same reference numerals as used in FIG. 1 are given to the corresponding components in FIG. 11.

A semiconductor device 40 according to the second embodiment includes a magnetic core 43 through which a wiring bar 11d and a wiring bar 12e pass. The material of the magnetic core 43 is ferrite, for example.

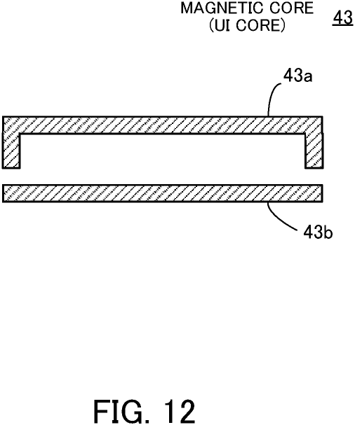

FIG. 12 illustrates an example of the magnetic core.

The magnetic core 43 is a UI core, for example, and includes a U-shaped part 43a and an I-shaped part 43b.

Semiconductor modules 41 and 42 respectively include housings 41a and 42a made of a resin, and the housings 41a and 42a each have a hollow for inserting the magnetic core 43 therein.

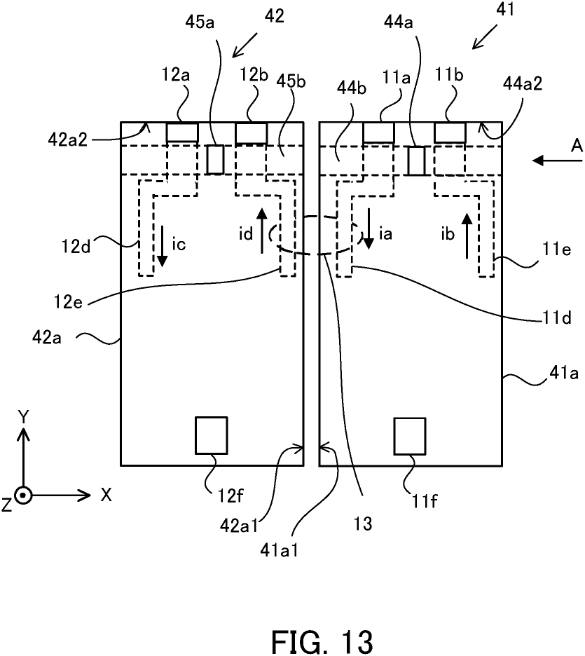

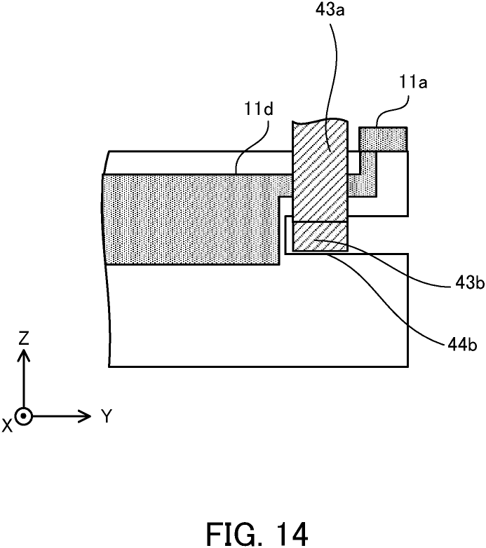

FIGS. 13 and 14 illustrate an example of hollows formed in housings.

The hollows are formed close to the sidewalls 42a2 and 44a2 where the P terminals 11a and 12a and N terminals 11b and 12b are disposed, and extend to the sidewalls 41a1 and 42a1 through the resin between the wiring bars 11d and 11e and between the wiring bars 12d and 12e. The hollows respectively include first portions 44a and 45a for inserting the U-shaped part 43a therein and second portions 44b and 45b for inserting the I-shaped part 43b therein. Referring to the example of FIG. 13, the second portions 44b and 45b extend to the sidewalls opposite to the sidewalls 41a1 and 42a1, respectively. This allows the I-shaped part 43b to be inserted from either the right or left in FIG. 13. The magnetic core 43 is usable in the case where the number of semiconductor modules connected in parallel increases.

FIG. 14 illustrates a positional relationship between the second portion 44b of a hollow and the wiring bar 11d, as seen from the arrow A of FIG. 13.

As illustrated in FIG. 14, the magnetic core 43 may be arranged so as to pass under the connection of the wiring bar 11d to the P terminal 11a.

Such an arrangement of the magnetic core 43 increases the mutual inductance M and also increases a voltage V = M × d(ia - id)/dt. This further enhances the effect of equalizing the current sharing.

### Modification

As described earlier, the wiring bar 11d may be formed inside the resin of the sidewall 11c1, and the wiring bar 11e may be formed inside the resin of the sidewall 11c2.

FIG. 15 is a top view of a semiconductor module, illustrating an example in which wiring bars are formed inside the resin of sidewalls.

In the example of FIG. 15, parts (indicated by broken lines) of the wiring bars 11d and 11e are formed inside the resin of the sidewalls 11c1 and 11c2.

Such a configuration makes it possible to further shorten the distance to a wiring bar (the wiring bar 12e in the example of FIG. 1) of a semiconductor module arranged adjacently in the X direction. This further enhances the effect of the mutual inductance and further enhances the effect of equalizing the current sharing.

One aspect of the semiconductor device and semiconductor module according to the present disclosure has been described using the embodiments, but these are just examples and are not limited to the above description.

Even in the case where semiconductor modules connected in parallel have different switching speeds, the disclosed technique makes it possible to equalize the current sharing between the semiconductor modules.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A semiconductor device for connection to a positive terminal and a negative terminal of a direct-current power source, the semiconductor device comprising:
a plurality of semiconductor modules connected in parallel between the positive terminal and the negative terminal of the direct-current power source, the plurality of semiconductor modules including:
a first semiconductor module, including:
a first input terminal electrically connected to the positive terminal,
a second input terminal electrically connected to the negative terminal,
a first housing, and
a first wiring bar that is provided in the first housing and is electrically connected to the first input terminal; and
a second semiconductor module, including:
a third input terminal electrically connected to the positive terminal,
a fourth input terminal electrically connected to the negative terminal,
a second housing, and
a second wiring bar that is provided in the second housing, is electrically connected to the fourth input terminal, and is magnetically coupled to the first wiring bar.

2. The semiconductor device according to claim 1, wherein the first wiring bar and the second wiring bar are disposed adjacent to each other in a first direction, and with a first sidewall of the first housing and a second sidewall of the second housing therebetween.

3. The semiconductor device according to claim 2, wherein the first wiring bar is disposed along the first sidewall, and the second wiring bar is disposed along the second sidewall.

4. The semiconductor device according to claim 3, wherein a length of the first wiring bar and a length the second wiring bar, both in a second direction, are respectively greater than a length of the first wiring bar and a length of the second wiring bar in the first direction, the second direction being a height direction of the first sidewall or the second sidewall.

5. The semiconductor device according to claim 1, wherein the first housing and the second housing are made of a resin.

6. The semiconductor device according to claim 1, further comprising a magnetic core through which the first wiring bar and the second wiring bar pass.

7. The semiconductor device according to claim 6, wherein
the magnetic core is a UI core, and
the first housing and the second housing each have a hollow for the UI core to be inserted therein.

8. A semiconductor module, comprising:
a housing formed of a resin, the housing including a first sidewall, a second sidewall facing the first sidewall, and a third sidewall connecting an end of the first sidewall and an end of the second sidewall,
a first wiring bar formed inside, or inscribed to, the resin of the first sidewall, the first wiring bar extending in an extending direction of the first sidewall, and
a second wiring bar formed inside, or inscribed to, the resin of the second sidewall, the second wiring bar extending in the extending direction of the first sidewall,
wherein the first wiring bar and the second wiring bar are electrically connected to an outside of the housing from the resin of the third sidewall.

9. The semiconductor module according to claim 8, wherein the housing has a hollow formed therein, adjacent to the third sidewall of the housing, and extending to the first sidewall or the second sidewall through the resin between the first wiring bar and the second wiring bar.
